(19) United States
(12) Patent Application Publication
(10) Pub. No.: US 2013/0326519 A1
(43) Pub. Date: Dec. 5, 2013

(54) VIRTUAL MACHINE CONTROL STRUCTURE SHADOWING

(71) Applicants: Andrew V. Anderson, Forest Grove, OR (US); Gilbert Neiger, Hillsboro, OR (US); Scott D. Rodgers, Hillsboro, OR (US); Lawrence O. Smith, III, Beaverton (UA); Richard A. Uhlig, Hillsboro, OR (US); Steven M. Bennett, Hillsboro, OR (US)

(72) Inventors: Andrew V. Anderson, Forest Grove, OR (US); Gilbert Neiger, Hillsboro, OR (US); Scott D. Rodgers, Hillsboro, OR (US); Lawrence O. Smith, III, Beaverton (UA); Richard A. Uhlig, Hillsboro, OR (US); Steven M. Bennett, Hillsboro, OR (US)

(21) Appl. No.: 13/995,317

(22) PCT Filed: Dec. 30, 2011
(86) PCT No.: PCT/US11/68126

§ 371 Date: Jun. 18, 2013

(51) Int. Cl. G06F 9/455

(52) U.S. Cl. CPC G06F 9/45533
USPC 718/1

(57) ABSTRACT

Embodiments of apparatuses and methods for processing virtual machine control structure shadowing are disclosed. In one embodiment, an apparatus includes instruction hardware, execution hardware, and control logic. The instruction hardware is to receive instructions. A first instruction is to transfer the processor from a root mode to a non-root mode. The non-root mode is for executing guest software in a virtual machine, where the processor is the return to root mode upon the detection of a virtual machine exit event. A second instruction is to access a data structure for controlling a virtual machine. The execution hardware is to execute the instructions. The control logic is to cause the processor to access a shadow data structure instead of the data structure, without returning to the root mode for the access to be performed, when the second instruction is executed in the non-root mode.

### BACKGROUND

1. Field

The present disclosure pertains to the field of information processing, and more particularly, to the field of virtualizing resources in information processing systems.

2. Description of Related Art

Generally, the concept of virtualization of resources in information processing systems allows multiple instances of one or more operating systems (each, an “OS”) to run on a single information processing system, even though each OS is designed to have complete, direct control over the system and its resources. Virtualization is typically implemented by using software (e.g., a virtual machine monitor, or “VMM”) to present to each OS a “virtual machine” (“VM”) having virtual resources, including one or more virtual processors, that the OS may completely and directly control, while the VMM maintains a system environment for implementing virtualization policies such as sharing and/or allocating the physical resources among the VMs (the “virtualization environment”). Each OS, and any other software, that runs on a VM is referred to as a “guest” or as “guest software,” while a “host” or “host software” is software, such as a VMM, that runs outside of the virtualization environment.

A processor in an information processing system may support virtualization, for example, by operating in two modes—a “root” mode in which software runs directly on the hardware, outside of any virtualization environment, and a “non-root” mode in which software runs at its intended privilege level, but within a virtualization environment hosted by a VMM running in root mode. In the virtualization environment, certain events, operations, and situations, such as external interrupts or attempts to access privileged registers or resources, may be intercepted, i.e., cause the processor to exit the virtualization environment so that the VMM may operate, for example, to implement virtualization policies (a “VM exit”). The processor may support instructions for establishing, entering, exiting, and maintaining a virtualization environment, and may include register bits or other structures that indicate or control virtualization capabilities of the processor.

### BRIEF DESCRIPTION OF THE FIGURES

The present invention is illustrated by way of example and not limitation in the accompanying figures.

FIG. 1 illustrates a layered virtualization architecture in which an embodiment of the present invention may operate.

FIG. 2 illustrates the guest hierarchy of a VMM in a layered virtualization architecture.

FIGS. 3, 4, and 5 illustrate methods for VMCS shadowing according to embodiments of the present invention.

### DETAILED DESCRIPTION

Embodiments of processors, methods, and systems for virtual machine control structure shadowing are described below. In this description, numerous specific details, such as component and system configurations, may be set forth in order to provide a more thorough understanding of the present invention. It will be appreciated, however, by one skilled in the art, that the invention may be practiced without such specific details. Additionally, some well known structures, circuits, and the like have not been shown in detail, to avoid unnecessarily obscuring the present invention.

The performance of a virtualization environment may be improved by reducing the frequency of VM exits. Embodiments of the invention may be used to reduce the frequency of VM exits in a layered, nested, or recursive virtualization environment, i.e., a virtualization environment in which a virtual machine monitor or hypervisor may run a guest, in non-root mode, on a virtual machine and create, manage, and/or otherwise host one or more other virtual machines.

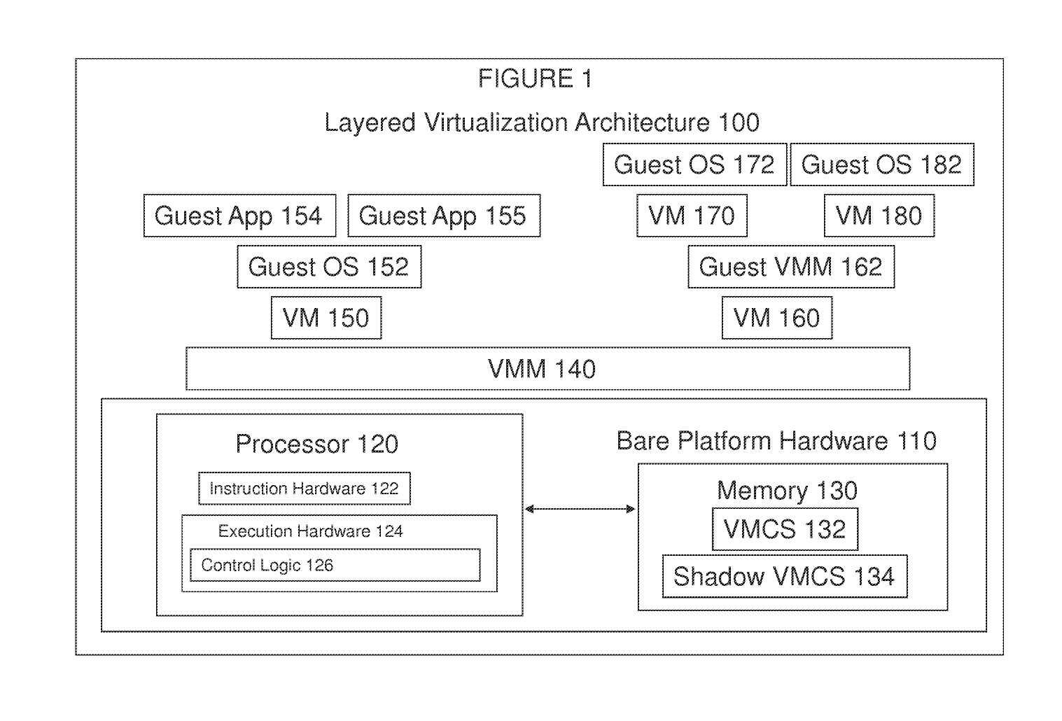

FIG. 1 illustrates layered virtualization architecture 100, in which an embodiment of the present invention may operate. In FIG. 1, bare platform hardware 110 may be any information processing apparatus capable of executing any OS, VMM, or other software. For example, bare platform hardware 110 may be that of a personal computer, mainframe computer, portable computer, handheld device, set-top box, or any other computing system. Bare platform hardware 110 includes processor 120 and memory 130.

Processor 120 may be any type of processor, including a general purpose microprocessor, such as a processor in the Core® Processor Family, the Atom® Processor Family, or other processor family from Intel Corporation, or another processor from another company, or a digital signal processor or microcontroller. Although FIG. 1 shows only one such processor 120, bare platform hardware 110 may include any number of processors, including any number of multicore processors, each with any number of execution cores and any number of multithreaded processors, each with any number of threads.

Memory 130 may be static or dynamic random access memory, semiconductor-based read only or flash memory, magnetic or optical disk memory, any other type of medium readable by processor 120, or any combination of such mediums. Processor 120, memory 130, and any other components or devices of bare platform hardware 110 may be coupled to or communicate with each other according to any known approach, such as directly or indirectly through one or more buses, point-to-point, or other wired or wireless connections. Bare platform hardware 110 may also include any number of additional devices or connections.

Additionally, processor 120 includes instruction hardware 122, execution hardware 124, and control logic 126. Instruction hardware 122 may include any circuitry or other hardware, such as a decoder, to receive and/or decode instructions for execution by processor 120. Execution hardware 124 may include any circuitry or other hardware, such as an arithmetic logic unit, to execute instructions for processor 120. Execution hardware may include or be controlled by control logic 126. Control logic 126 may be microcode, programmable logic, hard-coded logic, or any other form of control logic within processor 120. In other embodiments, control logic 126 may be implemented in any form of hardware, software, or firmware, such as a processor abstraction layer, within a processor or within any component accessible or medium readable by a processor, such as memory 130. Control logic 126 may cause execution logic 124 to execute method embodiments of the present invention, such as the method embodiments described below, for example, by causing processor 120 to include the execution of one or more micro-operations respond to virtualization instructions or virtualization events, or otherwise cause processor 120 to execute method embodiments of the present invention, as described below.

In addition to bare platform hardware 110, FIG. 1 illustrates VMM 140, which is a “root mode” host or monitor because it runs in root mode on processor 120. VMM 140 may be any software, firmware, or hardware host installed on or accessible to bare platform hardware 110, to present VMs, i.e., abstractions of bare platform hardware 110, to guests, or to otherwise create VMs, manage VMs, and implement virtualization policies. In other embodiments, a root mode host may be any monitor, hypervisor, OS, or other software, firmware, or hardware capable of controlling bare platform hardware 110.

A guest may be any OS, any VMM, including another instance of VMM 140, any hypervisor, or any application or other software. Each guest expects to access physical resources, such as processor and platform registers, memory, and input/output devices, of bare platform hardware 110, according to the architecture of the processor and the platform presented in the VM. FIG. 1 shows VMs 150, 160, 170, and 180, with guest OS 152 and guest applications 154 and 155 installed on VM 150, guest VMM 162 installed on VM 160, guest OS 172 installed on VM 170, and guest OS 182 installed on VM 180. In this embodiment, all guests run in non-root mode. Although FIG. 1 shows four VMs and six guests, any number of VMs may be created and any number of guests may be installed on each VM within the scope of the present invention.

Virtualization architecture 100 is “layered,” “nested,” or “recursive” because it allows one VMM, for example, VMM 140, to host another VMM, for example, VMM 162, as a guest. In layered virtualization architecture 100, VMM 140 is the host of the virtualization environment including VMs 150 and 160, and is not a guest in any virtualization environment because it is installed on bare platform hardware 110 with no “intervening” monitor between it and bare platform hardware 110. An “intervening” monitor is a monitor, such as VMM 162, that hosts a guest, such as guest OS 172, but is also a guest itself. VMM 162 is the host of the virtualization environment including VMs 170 and 180, but is also a guest in the virtualization environment hosted by VMM 140. An intervening monitor (e.g., VMM 162) is referred to herein as a parent guest, because it may function as both a parent to another VM (or hierarchy of VMs) and as a guest of an underlying VMM (e.g., VMM 140 is a parent of VMM 162 which is a parent to guests 172 and 182).

A monitor, such as VMM 140, is referred to as the “parent” of a guest, such as OS 152, guest application 154, guest application 155, and guest VMM 162, if there are no intervening monitors between it and the guest. The guest is referred to as the “child” of that monitor. A guest may be both a child and a parent. For example, guest VMM 162 is a child of VMM 140 and the parent of guest OS 172 and guest OS 182.

A resource that may be accessed by a guest may either be classified as a “privileged” or a “non-privileged” resource. For a privileged resource, a host (e.g., VMM 140) facilitates the functionality desired by the guest while retaining ultimate control over the resource. Non-privileged resources do not need to be controlled by the host and may be accessed directly by a guest.

Furthermore, each guest OS expects to handle various events such as exceptions (e.g., page faults, and general protection faults), interrupts (e.g., hardware interrupts and software interrupts), and platform events (e.g., initialization and system management interrupts). These exceptions, interrupts, and platform events are referred to collectively and individually as “events” herein. Some of these events are “privileged” because they must be handled by a host to ensure proper operation of VMs, protection of the host from guests, and protection of guests from each other. At any given time, processor 120 may be executing instructions from VMM 140 or any guest, thus VMM 140 or the guest may be active and running on, or in control of, processor 120. When a privileged event occurs or a guest attempts to access a privileged resource, a VM exit may occur, transferring control from the guest to VMM 140. After handling the event or facilitating the access to the resource appropriately, VMM 140 may return control to a guest. The transfer of control from a host to a guest (including an initial transfer to a newly created VM) is referred to as a “VM entry” herein. An instruction that is executed to transfer control to a VM may be referred to generically as a “VM enter” instruction, and for example, may include a VMLAUCH and a VMRESUME instruction in the instruction set architecture of a processor in the Core® Processor Family. In addition to a VM exit transferring control from a guest to a root mode host, as described above, embodiments of the present invention also provide for a VM exit to transfer control from a guest to a non-root mode host, such as an intervening monitor. In embodiments of the present invention, virtualization events (i.e., anything that may cause a VM exit) may be classified as “top-down” or “bottom-up” virtualization events.

A “top-down” virtualization event is one in which the determination of which host receives control in a VM exit is performed by starting with the parent of the active guest and proceeds towards the root mode host. Top-down virtualization events may be virtualization events that originate through actions of the active guest, including the execution of virtualized instructions such as the CPUID instruction in the instruction set architecture of a processor in the Core® Processor Family. In one embodiment, the root mode host may be provided with the ability to bypass top-down virtualization event processing for one or more virtualization events. In such an embodiment, the virtualization event may cause a VM exit to the root mode host even though it would be handled as a top-down virtualization event with regard to all intervening VMMs.

A “bottom-up” virtualization event is one in which the determination of which host receives control in a VM exit is performed in the opposite direction, e.g., from the root mode host towards the parent of the active guest. Bottom-up virtualization events may be virtualization events that originate by actions of the underlying platform, e.g., hardware interrupts and system management interrupts. In one embodiment, processor exceptions are treated as bottom-up virtualization events. For example, the occurrence of a page fault exception during execution of an active guest would be evaluated in a bottom-up fashion. This bottom-up processing may apply to all processor exceptions or a subset thereof.

Additionally, in one embodiment, a VMM has the ability to inject events (e.g., interrupts or exceptions) into its guests or otherwise induce such events. In such an embodiment, the determination of which host receives control in a VM exit may be performed by starting from above the VMM that induced the virtualization event, instead of from the root mode host.

In the embodiment of FIG. 1, processor 120 controls the operation of VMs according to data stored in virtual machine control structure (“VMCS”) 132. VMCS 132 is a data structure that may contain state of a guest or guests, state of VMM 140, execution control information indicating how VMM 140 is to control operation of a guest or guests, information regarding VM exits and VM entries, any other such information. Processor 120 reads information from VMCS 132 to determine the execution environment of a VM and constrain its behavior. In this embodiment, VMCS 132 is stored in memory 130. In some embodiments, multiple VMCSs are used to support multiple VMs, as described below. FIG. 1 also shows shadow VMCS 134, in memory 130 in this embodiment, which is created, maintained, and access as described below. Shadow VMCS 134 may have the same size, structure, organization, or any other feature as a VMCS that is not a shadow VMCS. In some embodiments, there may be multiple shadow VMCSs, for example, one per guest. In the method embodiments described below, shadow VMCS 134 is a shadow version of VMCS 251; however, another shadow VMCS (not shown) may be created to serve as a shadow version of VMCS 261.

The “guest hierarchy” of a VMM is the stack of software installed to run within the virtualization environment or environments supported by the VMM. The present invention may be embodied in a virtualization architecture in which guest hierarchies include chains of pointers between VMCSs. These pointers are referred to as “parent pointers” when pointing from the VMCS of a child to the VMCS of a parent, and as “child pointers” when pointing from the VMCS of a parent to the VMCS of a child. In the guest hierarchy of a VMM, there may be one or more intervening monitors between the VMM and the active guest. An intervening monitor that is closer to the VMM whose guest hierarchy is being considered is referred to as “lower” than an intervening monitor that is relatively closer to the active guest.

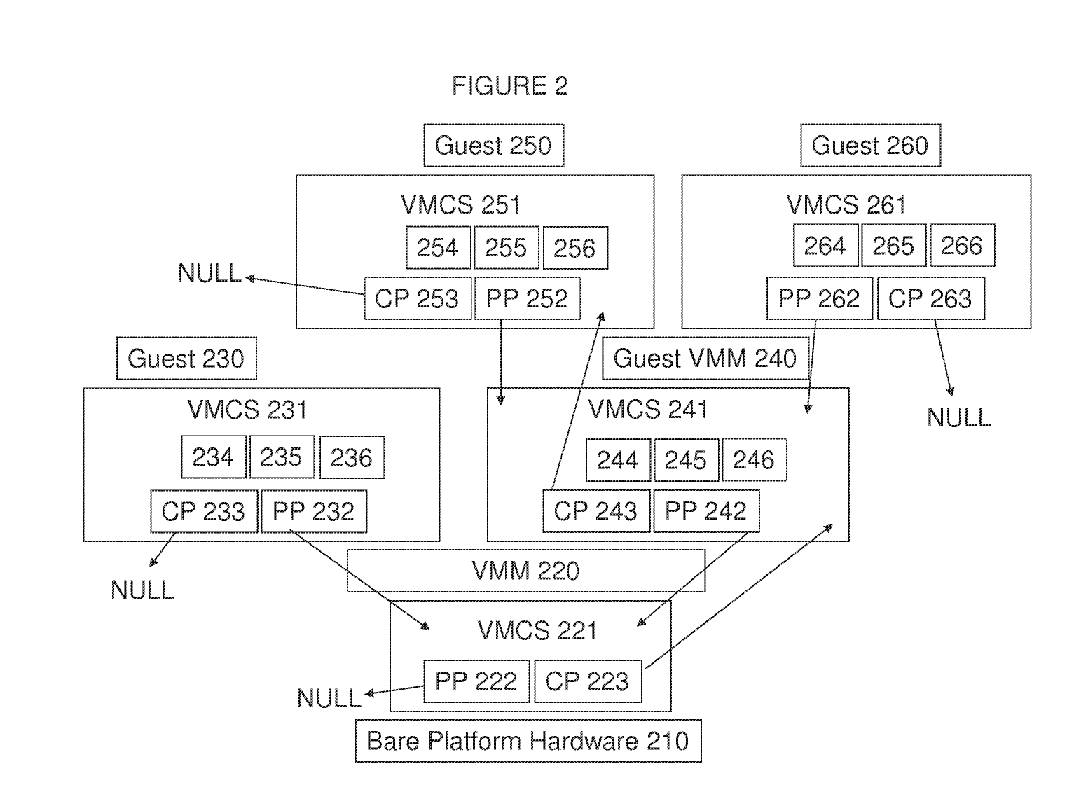

FIG. 2 illustrates the guest hierarchy of VMM 220, which is installed as a root mode host on bare platform hardware 210. VMCS 221 is a control structure for VMM 220, although a root mode host may operate without a control structure. Guest 230 is a child of VMM 220, controlled by VMCS 231. Therefore, parent pointer (“PP”) 232 points to VMCS 221. Guest 240 is also a child of VMM 220, controlled by VMCS 241. Therefore, parent pointer 242 also points to VMCS 221.

Guest 240 is itself a VMM, with two children, guests 250 and 260, each with a VMCS, 251 and 261, respectively. Both parent pointer 252 and parent pointer 262 point to VMCS 241.

The VMCS of a guest that is active, or running, is pointed to by the child pointer of its parent's VMCS. Therefore, FIG. 2 shows child pointer 243 pointing to VMCS 251 to indicate that guest 250 is active. Similarly, the VMCS of a guest with an active child pointer, as opposed to a null child pointer, is pointed to by the child pointer of its parent's VMCS. Therefore, FIG. 2 shows child pointer 223 pointing to VMCS 241. Consequently, a chain of parent pointers links the VMCS of an active guest through the VMCSs of any intervening monitors to the VMCS of a root mode host, and a chain of child pointers links the VMCS of a root mode host through the VMCSs of any intervening monitors to the VMCS of an active guest.

VMCS 221 is referred to herein as the “root VMCS”. In an embodiment, there is no root VMCS, as described above. In an embodiment which includes a root VMCS, the processing hardware may maintain a pointer to the root VMCS in an internal register or other data structure. The VMCS of a guest that is active, as described above, is referred to herein as the current controlling VMCS. For example, while guest 250 is active, VMCS 251 is the current controlling VMCS. In an embodiment, the processing hardware may maintain a pointer to the current controlling VMCS in an internal register or other data structure.

If a VMCS is not a parent VMCS, its child pointer, such as child pointers 233, 253, and 263, may be a null pointer. If a VMCS does not have a parent, for example, if it is a root-mode VMCS, its parent pointer, such as parent pointer 222, may be a null pointer. Alternatively, these pointers may be omitted. In some embodiments, the “null” value for a null VMCS pointer may be zero. In other embodiments, other values may be interpreted as “null”. For example, in one embodiment with 32-bit addresses, the value 0xffffffff may be interpreted as null.

Each guest's VMCS in FIG. 2 includes a bit, a field, or other data structure (an “event bit”) to indicate whether that guest's parent wants control if a particular virtualization event occurs. Each VMCS may include any number of such bits or fields to correspond to any number of virtualization events. Any number of event bits may be grouped together or otherwise referred to as an event bit field. FIG. 2 shows event bit fields 264, 254, 244, and 234.

Each guest's VMCS may include or refer to bits, fields, or other data structures to enable and control VMCS shadowing, according to various approaches. For example, a parent VMCS (e.g., VMCS 241) controlling a guest VMM may include a single bit (e.g., 245) to enable shadowing of a child VMCS (e.g., VMCS 251), and a field (e.g., 246) to specify the location of the corresponding shadow VMCS (e.g., a pointer to shadow VMCS 134). In other words, if guest VMM 240 attempts to access child VMCS 251 through a VMWRITE, VMREAD, or other means, the access may be directed to shadow VMCS 134 instead of child VMCS 251, if VMCS shadowing is enabled by bit 245.

Instead of or in combination with a single enable bit (e.g., 245), a parent VMCS may include or refer to (e.g., with a pointer) a pair of bitmaps, one for reads and one for writes, where each bit corresponds to a particular field of a VMCS, to selectively (by VMCS field) enable or disable VMCS shadowing for a child.

Therefore, VMCS shadowing enable fields 265, 255, 245, and 235 and VMCS shadow address fields 266, 256, 246, and 236 in FIG. 2 may each represent a single bit, a bit field, a bit map, or any other data structure, and may include the bits, bitmaps, and/or pointers referred to in the descriptions of the method embodiments below. In different embodiments, variations in the size, structure, organization, or other features the VMCS shadowing enable field may provide any desired level of granularity for VMCS shadowing.

If VMCS shadowing is not enabled, root VMM 220 maintains all of the VMCSs for guests in its guest hierarchy (e.g., VMCSs 231, 241, 251, and 261), and any attempt by an intervening monitor (e.g., guest VMM 240) to create (e.g., by executing a VMPTRLD instruction in the instruction set architecture of a processor in the Core® Processor Family) or maintain (e.g., by executing a VMWRITE instruction) a VMCS for one of its guests (e.g., VMCS 251 or 261), are intercepted and handled by root VMM 220. Attempts of an intervening monitor to perform a VM entry (e.g., by executing a VMLAUNCH or VMRESUME instruction) are also intercepted for emulation by root VMM 220. Attempted accesses (e.g., VMREAD and VMWRITE instructions) by an intervening monitor to a VMCS of one of its guests cause a VM exit to the root VMCS for emulation of the access instruction, and each of these VM exits adds latency for the transition, for execution of the VMM handler code, and due to changes to the contents of translation lookaside buffers and caches that result from the transition. The net impact of these VM exits may significantly degrade performance.

Therefore, embodiments of the present invention provide for the creation and maintenance of a shadow VMCS, which may be accessed by the intervening monitor without causing a VM exit to the root VMM, as set forth in the following descriptions of method embodiments of the present invention. Control logic 126 may provide for access to the shadow

VMCS by redirecting the intervening monitor's attempted access without causing a VM exit.

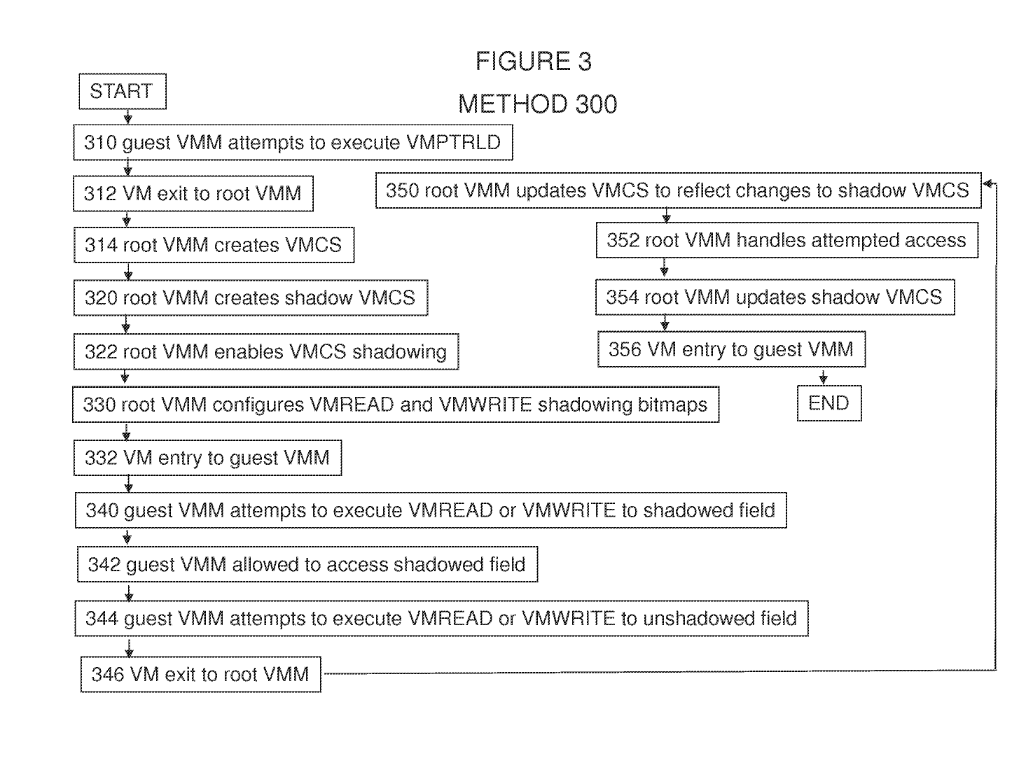

FIGS. 3, 4, and 5 illustrate methods 300, 400, and 500, respectively, for VMCS shadowing according to embodiments of the present invention. Descriptions of these methods refer to elements of FIGS. 1 and 2. Specifically, in these descriptions, reference is made to the creation and maintenance of shadow VMCS 134 for VMCS 251, such that guest VMM 240 may access shadow VMCS 134 without causing a VM exit to root VMM 220. However, embodiments of the present invention may vary from the described embodiments; for example, a shadow VMCS may also be created and maintained for VMCS 261, such that guest VMM 240 may access that shadow VMCS without causing a VM exit to root VMM 220. Similarly, a first guest VMM may create a shadow VMCS for a second guest VMM that is in the guest hierarchy of the first guest VMM. In the described embodiments, methods 300, 400, and 500 begin after root VMM 220 has transferred control to guest VMM 240, and end with guest VMM 240 executing in the VM controlled by VMCS 251.

In box 310 of FIG. 3, guest VMM 240 attempts to execute an instruction (e.g., VMPTRLD) to specify a VMCS (e.g., VMCS 251) to control a VM in which a guest (e.g., guest 250) may execute. In box 312, a VM exit to root VMM 220 is caused by the attempted execution of the VMPTRLD instruction within a VM. In box 314, root VMM 220 creates the VMCS (e.g., VMCS 251) on behalf of guest VMM 240.

In box 320, root VMM 220 allocates memory for a shadow VMCS (e.g., shadow VMCS 134 in memory 130). In box 322, root VMM 220 sets an indicator (e.g., a control bit in VMCS shadowing enable field 245) in VMCS 241 to enable VMCS shadowing, and sets VMCS shadow address field 246 to the address of the shadow VMCS allocated in box 320.

In method embodiment 300 of FIG. 3, VMCS shadowing enable field 255 includes two bitmaps, one for VMCS reads (the “VMREAD shadowing bitmap”) and one for VMCS writes (the “VMWRITE shadowing bitmap”). Each bitmap includes an enable bit for each field in VMCS 251. Therefore, VMCS shadowing may be selectively enabled for reading any field in VMCS 251 by setting the corresponding enable bit in the VMREAD shadowing bitmap, and selectively enabled for writing any field in VMCS 251 by setting the corresponding enable bit in the VMWRITE shadowing bitmap. The same field may have shadowing enabled for reads but not writes, or vice versa.

In box 330, root VMM 220 configures the VMREAD and VMWRITE shadowing bitmaps in VMCS 251 by setting the enable bits corresponding to each field for which shadowing is desired. In box 332, root VMM 220 causes a VM entry to return control to guest VMM 240 (e.g., by executing a VMRESUME instruction). In box 340, guest VMM 240 attempts to access (e.g., by executing a VMREAD or VMWRITE instruction) a field in VMCS 251 for which shadowing is enabled. In box 342, guest VMM 240 is allowed to access the corresponding field in shadow VMCS 134. In box 344, guest VMM 240 attempts to access a field in VMCS 251 for which shadowing is not enabled. In box 346, a VM exit to root VMM 220 is caused by the attempt to access a VMCS field for which shadowing is not enabled.

Any number of accesses for which shadowing is enabled may occur and any number of other instructions may be executed, by guest VMM 240 or by any guest in the guest hierarchy of guest VMM 240, between box 340 and box 344, as long as a VM exit does not occur before box 346. Also, a VM exit may be caused by an event other than that in box 344.

In box 350, root VMM 220 updates VMCS 251 to reflect any writes that were made to shadow VMCS 134 by guest VMM 240, for example, as a result of box 342. In box 352, root VMM 220 emulates or otherwise handles, on behalf of guest VMM 240, the access attempted in box 344, and performs any other actions necessary or desired to handle the VM exit. In box 354, root VMM 220 updates shadow VMCS 134 to reflect any changes made to VMCS 251 during the handling of the VM exit in box 352. In box 356, root VMM 220 causes a VM entry to return control to guest VMM 240 (e.g., by executing a VMRESUME instruction).

In other embodiments, the synchronization of VMCS 251 and shadow VMCS 134 (e.g., as depicted in boxes 350 to 354), root VMM 220 may update VMCS at a different time, for example, the synchronization need not occur in response to a VM exit from the guest with a shadowed VMCS, but may instead occur later in response to the next VM entry into that guest.

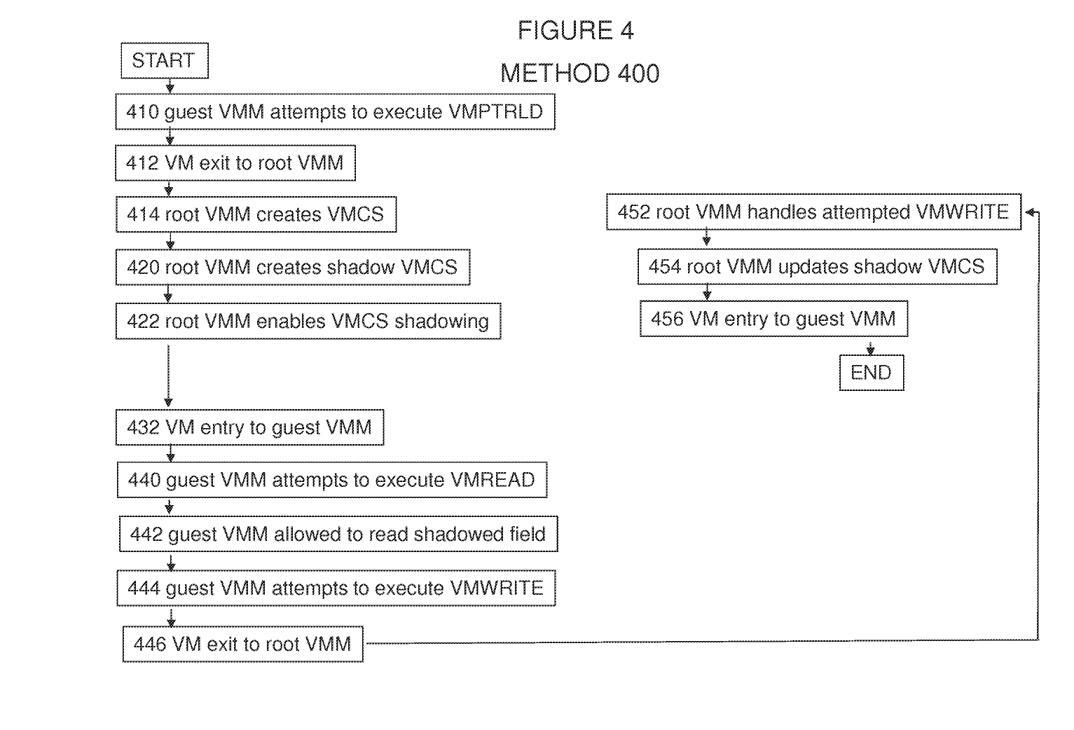

In method embodiment 400 of FIG. 4, all VMREADs are shadowed and no VMWRITES are shadowed.

In box 410 of FIG. 4, guest VMM 240 attempts to execute an instruction (e.g., VMPTRLD) to specify a VMCS (e.g., VMCS 251) to control a VM in which a guest (e.g., guest 250) may execute. In box 412, a VM exit to root VMM 220 is caused by the attempted execution of the VMPTRLD instruction within a VM. In box 414, root VMM 220 creates the VMCS (e.g., VMCS 251) on behalf of guest VMM 240.

In box 420, root VMM 220 allocates memory for a shadow VMCS (e.g., shadow VMCS 134 in memory 130). In box 422, root VMM 220 sets an indicator (e.g., a control bit in VMCS shadowing enable field 245) in VMCS 241 to enable VMCS shadowing, and sets VMCS shadow address field 246 to the address of the shadow VMCS allocated in box 420. In box 432, root VMM 220 causes a VM entry to return control to guest VMM 240 (e.g., by executing a VMRESUME instruction).

In box 440, guest VMM 240 attempts to read from (e.g., by executing a VMREAD instruction) a field in VMCS 251. In box 442, guest VMM 240 is allowed to read the corresponding field in shadow VMCS 134. In box 444, guest VMM 240 attempts to write to (e.g., by executing a VMWRITE instruction) a field in VMCS 251. In box 446, a VM exit to root VMM 220 is caused by the attempt to write to a VMCS field.

Any number of VMCS reads may occur and any number of other instructions (except

VMWRITEs) may be executed, by guest VMM 240 or by any guest in the guest hierarchy of guest VMM 240, between box 440 and box 444, as long as a VM exit does not occur before box 446. Also, a VM exit may be caused by an event other than that in box 444.

In box 452, root VMM 220 emulates or otherwise handles, on behalf of guest VMM 240, the VMCS write attempted in box 344, and performs any other actions necessary or desired to handle the VM exit. In box 454, root VMM 220 updates shadow VMCS 134 to reflect any changes made to VMCS 251 during the handling of the VM exit in box 452. In box 456, root VMM 220 causes a VM entry to return control to guest VMM 240 (e.g., by executing a VMRESUME instruction).

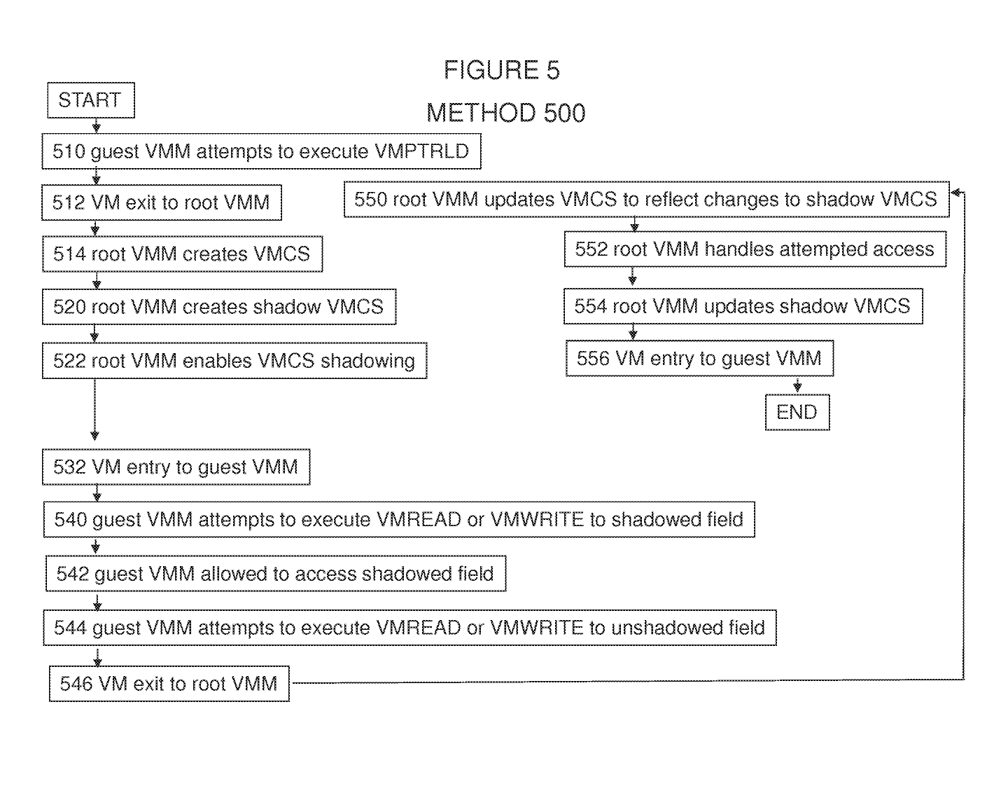

In method embodiment 500 of FIG. 5, the VMCS fields to which VMCS reads are shadowed and the VMCS fields to which VMCS writes are shadowed is hard-coded (i.e., no programmable bit maps are provided). For example, in one embodiment, all VMCS reads are shadowed, VMCS writes to RIP (instruction pointer register), EFLAGS (program status and control register), and guest interruptibility state are shadowed, but no other VMCS writes are shadowed.

In box 510 of FIG. 5, guest VMM 240 attempts to execute an instruction (e.g., VMPTRLD) to specify a VMCS (e.g., VMCS 251) to control a VM in which a guest (e.g., guest 250) may execute. In box 512, a VM exit to root VMM 220 is caused by the attempted execution of the VMPTRLD instruction within a VM. In box 514, root VMM 220 creates the VMCS (e.g., VMCS 251) on behalf of guest VMM 240.

In box 520, root VMM 220 allocates memory for a shadow VMCS (e.g., shadow VMCS 134 in memory 130). In box 522, root VMM 220 sets an indicator (e.g., a control bit in VMCS shadowing enable field 245) in VMCS 241 to enable VMCS shadowing, and sets VMCS shadow address field 246 to the address of the shadow VMCS allocated in box 520. In box 532, root VMM 220 causes a VM entry to return control to guest VMM 240 (e.g., by executing a VMRESUME instruction).

In box 540, guest VMM 240 attempts to access (e.g., by executing a VMREAD or VMWRITE instruction) a field in VMCS 251 for which shadowing is enabled (hard-coded). In box 542, guest VMM 240 is allowed to access the corresponding field in shadow VMCS 134. In box 544, guest VMM 240 attempts to access a field in VMCS 251 for which shadowing is not enabled. In box 546, a VM exit to root VMM 220 is caused by the attempt to access a VMCS field for which shadowing is not enabled.

Any number of accesses for which shadowing is enabled may occur and any number of other instructions may be executed, by guest VMM 240 or by any guest in the guest hierarchy of guest VMM 240, between box 540 and box 544, as long as a VM exit does not occur before box 546. Also, a VM exit may be caused by an event other than that in box 544.

In box 550, root VMM 220 updates VMCS 251 to reflect any writes that were made to shadow VMCS 134 by guest VMM 240, for example, as a result of box 542. In box 552, root VMM 220 emulates or otherwise handles, on behalf of guest VMM 240, the access attempted in box 544, and performs any other actions necessary or desired to handle the VM exit. In box 554, root VMM 220 updates shadow VMCS 134 to reflect any changes made to VMCS 251 during the handling of the VM exit in box 552. In box 556, root VMM 220 causes a VM entry to return control to guest VMM 240 (e.g., by executing a VMRESUME instruction).

Within the scope of the present invention, the methods illustrated in FIGS. 3, 4, and 5 may be performed in a different order, with illustrated boxes omitted, with additional boxes added, or with a combination of reordered, omitted, or additional boxes.

In the preceding description, the term “setting” may have been used to refer to writing a value of logical “1” to a bit storage location, and “clearing” may have been used to refer to writing a value of logical “0” to a bit storage location. Similarly, setting an enable bit may result in enabling a function controlled by that enable bit, and clearing an enable bit may result in disabling the function. However, the embodiments of the present invention are not limited by any of this nomenclature. For example, “setting” an indicator may refer to writing one of one or more specific values to a storage location for one or more than one bit. Similarly, reverse conventions may be used, in which setting may mean writing a logical “0” and/or in which an enable bit is cleared to enable a function.

Some portions of the above descriptions have been presented in terms of algorithms and symbolic representations of operations on data bits within a computer system's registers or memory. These algorithmic descriptions and representations are the means used by those skilled in the data processing arts to effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It may have proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, it is to be appreciated that throughout the present invention, discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer-system memories or registers or other such information storage, transmission or display devices.

Thus, processors, methods, and systems for VMCS shadowing have been disclosed. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
instruction hardware to receive a plurality of instructions, including a first instruction to transfer the processor from a root mode to a non-root mode for executing guest software in at least one virtual machine, wherein the processor is to return to the root mode upon the detection of any of a plurality of virtual machine exit events, and a second instruction to access at least one data structure for controlling the at least one virtual machine; and
execution hardware to execute the first instruction and the second instruction; and
control logic to cause the processor to access a shadow data structure instead of the at least one data structure, without returning to the root mode for the access to be performed, when the second instruction is executed in the non-root mode.

2. The processor of claim 1, wherein the control logic is to cause the processor to return to the root mode in response to an attempt to create the at least one data structure in the non-root mode.

3. The processor of claim 1, wherein the control logic is to cause the processor to return to the root mode, instead of accessing the shadow data structure, in response to an attempt in the non-root mode to access a field in the data structure for which shadowing is not enabled.

4. A method comprising:
receiving, by a processor, a virtual machine enter instruction;
executing, by the processor, the virtual machine enter instruction to transfer control from a root virtual machine monitor in a root mode to a guest virtual machine monitor in a non-root mode;
attempting, by the guest virtual machine monitor running in the non-root mode on the processor, to access a child virtual machine control structure; and
causing, by control logic in the processor, the access to be redirected to a shadow virtual machine control structure without returning to the root mode to perform the access.

5. The method of claim 4, wherein attempting includes attempting to access the child virtual machine control structure for controlling a child virtual machine hosted by the guest virtual machine monitor.

6. The method of claim 4, further comprising enabling, by the root virtual machine monitor, shadowing by setting a shadowing enable indicator in a parent virtual machine control structure for controlling a parent virtual machine running the guest virtual machine monitor.

7. The method of claim 4, wherein attempting includes attempting to execute an instruction to read from the child virtual machine control structure.

8. The method of claim 4, wherein attempting includes attempting to execute an instruction to write to the child virtual machine control structure.

9. The method of claim 4, further comprising configuring, by the root virtual machine monitor, a virtual machine control structure read shadowing bitmap for the child virtual machine data structure.

10. The method of claim 9, wherein the virtual machine control structure read shadowing bitmap includes a plurality of shadowing enable bits, each of the shadowing enable bits corresponding to one of a plurality of fields in the child virtual machine control structure, and wherein configuring includes setting each of the shadowing enable bits corresponding to one of the plurality of child virtual machine control structure fields to be read without causing a virtual machine exit.

11. The method of claim 4, further comprising configuring, by the root virtual machine monitor, a virtual machine control structure write shadowing bitmap for the child virtual machine control structure.

12. The method of claim 11, wherein the virtual machine control structure write shadowing bitmap includes a plurality of shadowing enable bits, each of the shadowing enable bits corresponding to one of a plurality of fields in the child virtual machine control structure, and wherein configuring includes setting each of the shadowing enable bits corresponding to one of the plurality of child virtual machine control structure fields to be written without causing a virtual machine exit.

13. The method of claim 4, further comprising:
attempting, by the guest virtual machine monitor running in the non-root mode on the processor, to create a child virtual machine control structure;
causing, by control logic in the processor in response to the attempt, control to be transferred from the non-root mode to the root-mode;
creating, by the root virtual machine monitor running in the root mode, the child virtual machine control structure; and
creating, by the root virtual machine monitor running in the root mode, the shadow virtual machine control structure.

14. The method of claim 4, further comprising:
attempting, by the guest virtual machine monitor running in the non-root mode on the processor, to access a field in the child virtual machine structure for which shadowing is not enabled; and
causing, by control logic in the processor in response to the attempt, control to be transferred from the non-root mode to the root-mode.

15. The method of claim 14, further comprising:
updating, by the root virtual machine monitor running in the root mode, the child virtual machine control structure to reflect changes made to the shadow virtual machine control structure by the non-root virtual machine monitor running in the non-root mode.

16. The method of claim 14, further comprising:
updating, by the root virtual machine monitor running in the root mode, the shadow virtual machine control structure to reflect changes made to the child virtual machine control structure by the root virtual machine monitor running in the root mode.

17. A system comprising:
a memory to store at least one data structure for controlling at least one virtual machine and at least one shadow data structure; and
a processor including
instruction hardware to receive a plurality of instructions, including a first instruction to transfer the processor from a root mode to a non-root mode for executing guest software in at least one virtual machine, wherein the processor is to return to the root mode upon the detection of any of a plurality of virtual machine exit events, and a second instruction to access at least one data structure, and
execution hardware to execute the first instruction and the second instruction, and
control logic to cause the processor to access the shadow data structure instead of the at least one data structure, without returning to the root mode for the access to be performed, when the second instruction is executed in non-root mode.

18. The system of claim 17, wherein the memory is to store a first data structure to be created by a root virtual machine monitor running in the root mode, the first data structure to control a first virtual machine in which a guest virtual machine monitor is to run in the non-root mode.

19. The system of claim 19, wherein the memory is also to store a second data structure to be created by a guest virtual machine monitor running in the non-root mode, the second data structure to control a second virtual machine to be hosted by the guest virtual machine monitor.

20. The system of claim 19, wherein the memory is also to store a shadow data structure to be created by the root mode monitor running in the root mode, the shadow data structure to be accessed by the guest virtual machine monitor running in the non-root mode in the first virtual machine, without causing a virtual machine exit to the root mode.
